(19) United States
(12) Patent Application Publication
(10) Pub. No.: US 2013/0232537 A1
(43) Pub. Date: Sep. 5, 2013

(54) PACKET FILTERING AT A MEDIA CONVERTER IN A NETWORK WITH OPTICAL AND COAXIAL COMPONENTS

(71) Applicants: Juan Montojo, San Diego, CA (US); Andrea Garavaglia, Nuremberg (DE); Nicola Varanese, Nuremberg (DE); Christian Pietsch, Nuremberg (DE)

(72) Inventors: Juan Montojo, San Diego, CA (US); Andrea Garavaglia, Nuremberg (DE); Nicola Varanese, Nuremberg (DE); Christian Pietsch, Nuremberg (DE)

(73) Assignee: Qualcomm Atheros, Inc., San Jose, CA (US)

(21) Appl. No.: 13/609,175

(22) Filed: Sep. 10, 2012

Related U.S. Application Data
(60) Provisional application No. 61/606,440, filed on Mar. 4, 2012.

(51) Int. Cl. H04N 21/61

(52) U.S. Cl. 725/129

(57) ABSTRACT

A media converter is coupled to an optical link terminal and a plurality of coax network units in a cable plant. The media converter receives packets from the optical link terminal via an optical link. The packets include first packets addressed to coax network units on the cable plant and second packets addressed to network units outside of the cable plant. The media converter forwards the first packets to the coax network units on the cable plant via one or more coax links, such that the first packets are forwarded to each coax network unit on the cable plant, and discards the second packets.

### RELATED APPLICATION

This application-claims priority to U.S. Provisional Patent Application No. 61/606,440, titled “Packet Filtering at a Media Converter in a Hybrid Fiber-Coaxial Network,” filed Mar. 4, 2012, which is hereby incorporated by reference in its entirety.

### TECHNICAL FIELD

The present embodiments relate generally to communication systems, and specifically to communication systems with both optical fiber links and coaxial cable (“coax”) links.

### BACKGROUND OF RELATED ART

A network may use both optical fiber and coaxial cable for respective links. For example, the portions of the network that use optical fiber may be implemented using the Ethernet Passive Optical Networks (EPON) protocol, and the EPON protocol may be extended over coaxial cable plants. EPON over coax is called EPOC. The fiber part of the network can potentially support a higher data rate than the coax part of the network. Also, different coax parts of the network (e.g., different cable plants) may have different maximum data rates. Slow coax links thus can limit overall system performance. For example, if the Ethernet Passive Optical Networks protocol is implemented in a network with both fiber (EPON) and coax (EPoC) links, the overall data rate may be limited by the lowest data rate of the worst coax link.

Accordingly, there is a need for fiber-to-coax media converters that can accommodate different data rates for different links.

### BRIEF DESCRIPTION OF THE DRAWINGS

The present embodiments are illustrated by way of example and are not intended to be limited by the figures of the accompanying drawings.

FIG. 1 is a block diagram of a network with both optical fiber links and coax links in accordance with some embodiments.

FIG. 2 illustrates an auto-discovery procedure between an optical link terminal and optical network units.

FIG. 3 illustrates an auto-discovery procedure between an optical link terminal and coax network units in accordance with some embodiments.

FIG. 4A is a schematic block diagram of a media converter in a network with both optical fiber links and coax links in accordance with some embodiments.

FIG. 4B is a schematic block diagram of a media converter in a network with both optical fiber links and coax links in accordance with some embodiments.

FIG. 5A is a flowchart illustrating a method of filtering packets in a media converter in accordance with some embodiments.

FIG. 5B is a flowchart illustrating a method of creating and updating a filtering template in accordance with some embodiments.

Like reference numerals refer to corresponding parts throughout the figures and specification.

### DETAILED DESCRIPTION

Embodiments are disclosed in which a media converter forward onto a coax medium only a portion of the optical packets that it receives.

In some embodiments, a media converter coupled to an optical link terminal and to a plurality of coax network units on a cable plant receives packets from the optical link terminal via an optical link. The packets include first packets addressed to coax network units on the cable plant and second packets addressed to network units outside of the cable plant. The media converter forwards the first packets to the coax network units on the cable plant via one or more coax links, such that the first packets are forwarded to each coax network unit on the cable plant, and discards the second packets.

In some embodiments, a media converter includes an optical port to be coupled to an optical link and a coax port to be coupled to a cable plant. The media converter also includes a packet sniffing and filtering module, coupled between the optical port and the coax port, to filter packets received on the optical port. The packet sniffing and filtering module forwards packets addressed to coax network units on the cable plant to the coax port for transmission and discards packets addressed to network units outside of the cable plant.

In some embodiments, a non-transitory computer-readable storage medium stores instructions that, when executed by one or more processors in a media converter, cause the media converter to extract identifiers of destination coax network units from packets received on an optical port, compare the extracted identifiers to a filter template storing identifiers of coax network units, forward packets for which the extracted identifiers match an identifier in the filter template, and discard packets for which the extracted identifiers do not match any identifiers in the filter template.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

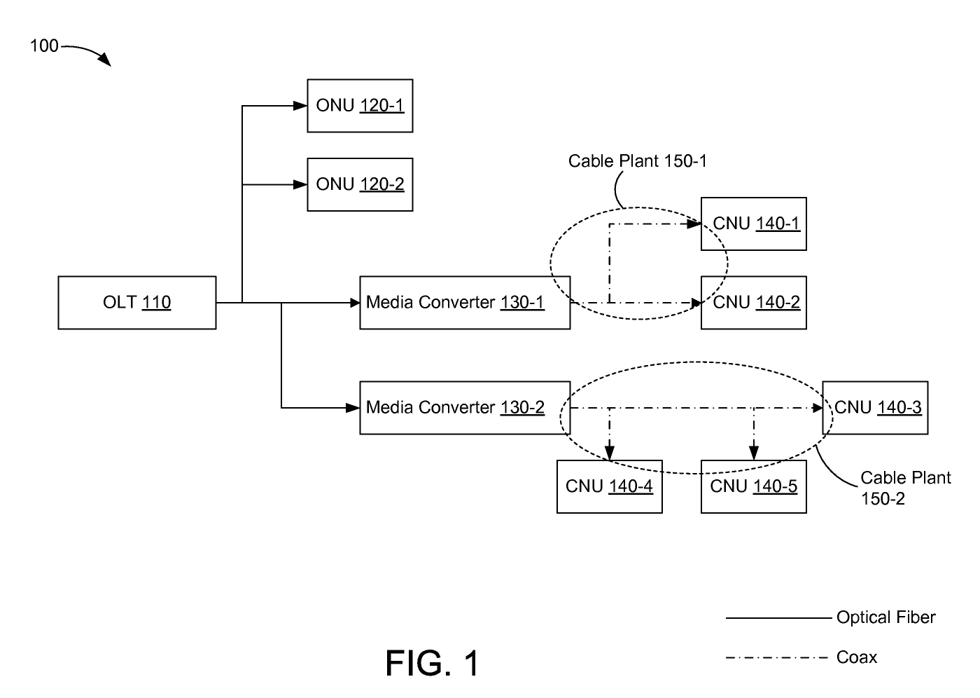

FIG. 1 is a block diagram of a network 100 that includes both optical fiber links and coax links in accordance with some embodiments. The network 100 includes an optical link terminal (OLT) 110 (which may also be referred to as an optical line terminal) coupled to a plurality of optical network units (ONUs) 120-1 and 120-2 via respective optical fiber links. The OLT 110 also is coupled to a plurality of media converters 130-1 and 130-2 via respective optical fiber links. The media converters 130-1 and 130-2, which may also be referred to as coax media converters (CMCs) or optical-coax units (OCUs), convert optical signals from the OLT 110 into electrical signals and transmit the electrical signals to coax network units (CNUs) via respective coax links. In the example of FIG. 1, a first media converter 130-1 transmits converted signals to CNUs 140-1 and 140-2, and a second media converter 130-2 transmits converted signals to CNUs 140-3, 140-4, and 140-5. The coax links coupling the first media converter 130-1 to CNUs 140-1 and 140-2 compose a first cable plant 150-1. The coax links coupling the second media converter 130-2 to CNUs 140-3 through 140-5 compose a second cable plant 150-2. In some embodiments, the OLT 110, ONUs 120-1 and 120-2, and media converters 130-1 and 130-2 are implemented in accordance with the Ethernet Passive Optical Network (EPON) protocol. In some embodiments, the OLT 110 transmits optical signals using time-domain multiplexing (TDM), such that different time slots are used to transmit packets addressed to different network units.

In some embodiments, the OLT 110 is located at the network operator's headend, the ONUs 120 and CNUs 140 are located at the premises of respective users, and the media converters 130 are located at the headends of respective cable plant operators. Alternatively, media converters 130 may be located within cable plants.

In some embodiments, each ONU 120 and media converter 130 in the network 100 receives data at the same data rate. The ONUs 120 and media converters 130 each receive all of the packets transmitted by the OLT 110. For unicast transmissions, each ONU 120 receives every packet transmitted by the OLT 110, but selects only the packets addressed to it, and discards all packets that are not addressed to it.

For unicast transmissions, the media converters 130 also receive every packet transmitted by the OLT 110, but filter out the packets not addressed to CNUs 140 on their respective cable plants 150. For example, the media converter 130-1 receives every packet transmitted by the OLT 110 but forwards only those packets addressed to the CNUs 140-1 and 140-2 on the cable plant 150-1. The media converter 130-1 forwards each packet addressed to one of the CNUs 140-1 and 140-2 on the cable plant 150-1 to every CNU 140-1 and 140-2 on the cable plant 150-1. Each CNU 140-1 and 140-2 selects the packets addressed to it and discards other packets. The media converter 130-2 and CNUs 140-3 through 140-5 function similarly.

In some embodiments, the optical fiber links in the network 100 can support higher data rates than the coax links. In one example, the optical links can support data rates of 10 Gbps, while the coax links can support data rates of 1 Gbps. Despite this difference, the OLT 110 transmits at the higher data rate of the optical links (e.g., 10 Gbps). The filtering performed by the media converters 130 prevents the coax links from limiting data rates of the optical links and thus the overall network performance. Because only a portion of the packets transmitted by the OLT 110 are forwarded by the media converters 130, the coax links can operate at lower data rates than the optical links, which can operate at their maximum potential speed in accordance with some embodiments. By allowing the optical links to operate at full speed, the filtering thus avoids wasting bandwidth.

In some embodiments, the data rates of respective coax links vary according to link quality and available bandwidth. Even within a particular cable plant 150, different CNUs 140 (and thus, different users) may see different channel conditions. The media converters 130-1 and 130-2 therefore are configurable to transmit coax signals using different modulation and coding schemes (MCSs). For example, different MCSs may be used for different CNUs in a cable plant. (Alternatively, a data rate is chosen such that all CNUs 140 on a cable plant 150 can decode all broadcast packets.) Different multiplexing scheme may be used for different cable links, such as TDM, frequency-division multiplexing (FDM), code-division multiplexing (CDM), and various combinations of such multiplexing schemes.

In some embodiments, an MCS is chosen such that when a code word combines packets for different CNUs 140, all of these CNUs are able to decode the code word.

In some embodiments, as mentioned, MCSs are chosen independently for different CNUs 140, even within the same cable plant 150. For a respective CNU 140, an MCS is chosen to provide an adequate data rate (e.g., to maximize the data rate) based on the link quality for the CNU 140. Also, data rates can be improved or optimized with an appropriate assignment of resources. For example, in a cable plant 150, two CNUs 140 may see a frequency notch, but at different frequencies. Frequency resources are assigned such that each CNU 140 sees a good channel where its own data is transmitted.

Each media converter 130 filters packets (e.g., with corresponding frames, such as Ethernet frames) from the OLT 110 so that only frames addressed to any of the registered CNUs 140 coupled to the converter 130 are forwarded. The media converter 130 builds and manages a filtering template to select the frames to be forwarded. The filtering is based, for example, on the logical link identifier (LLID) encapsulated in the preamble of the frame.

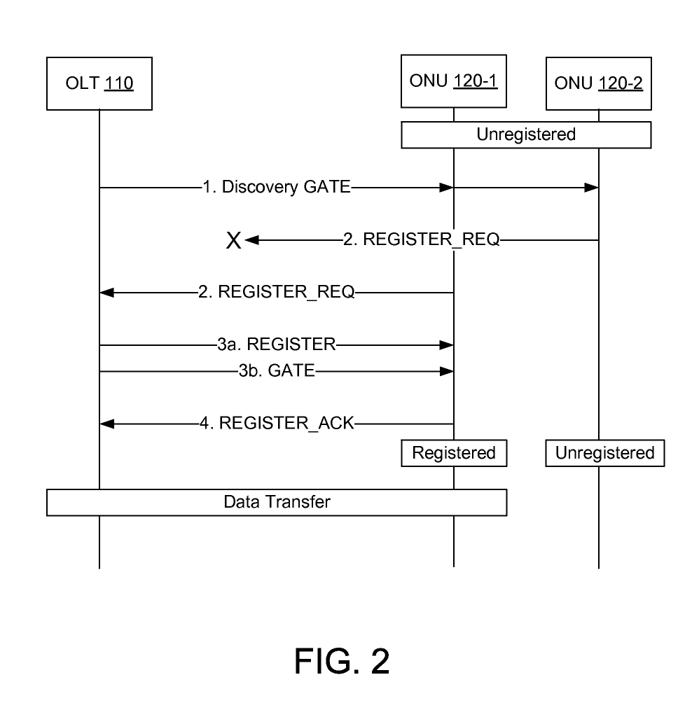

To build and manage the filtering template, the media converter may exploit an auto-discovery procedure for network units (e.g., the EPON multi-point control protocol (MPCP), as standardized in the IEEE 802.3 Ethernet standard) in which messages (e.g., MPCP messages) are transmitted between the network units. FIG. 2 illustrates this auto-discovery procedure as performed for the OLT 110 and ONUs 120-1 and 120-2. At the beginning of this procedure, ONU 120-1 and ONU 120-2 are both unregistered with the OLT 110. The OLT 110 periodically distributes special GATE messages, called discovery GATE messages, to trigger registration of unregistered network units. At step 1 of the procedure, the OLT 110 distributes one of these discovery GATE messages. At step 2, unregistered ONUs 120-1 and 120-2 attempt to register, competing for upstream transmission by replying with a registration request (REGISTER_REQ) message. (The same message can also be issued by an ONU to unregister.) In the example of FIG. 2, the ONU 120-1 succeeds in transmitting its REGISTER_REQ message to the OLT 110, but the ONU 120-2 fails. When the OLT 110 decodes the REGISTER_REQ message from the ONU 120-1, it replies to the ONU 120-1 (at step 3a) with a registration (REGISTER) message that assigns a unique LLID to that ONU, and immediately sends a unicast GATE message to the ONU 120-1 (at step 3b). (The OLT 110 can also instruct the ONU 120-1 to unregister.) The ONU 120-1 replies at step 4 with a registration acknowledgment (REGISTER_ACK) message to complete registration or with a non-acknowledgment (NACK) message if registration fails. Once the OLT 110 receives REGISTER_ACK, the ONU 120-1 is registered with the OLT 110, but the ONU 120-2 remains unregistered. Data transfer now can occur between the OLT 110 and ONU 120-1. The ONU 120-2 can attempt to register again in response to a subsequent discovery GATE message.

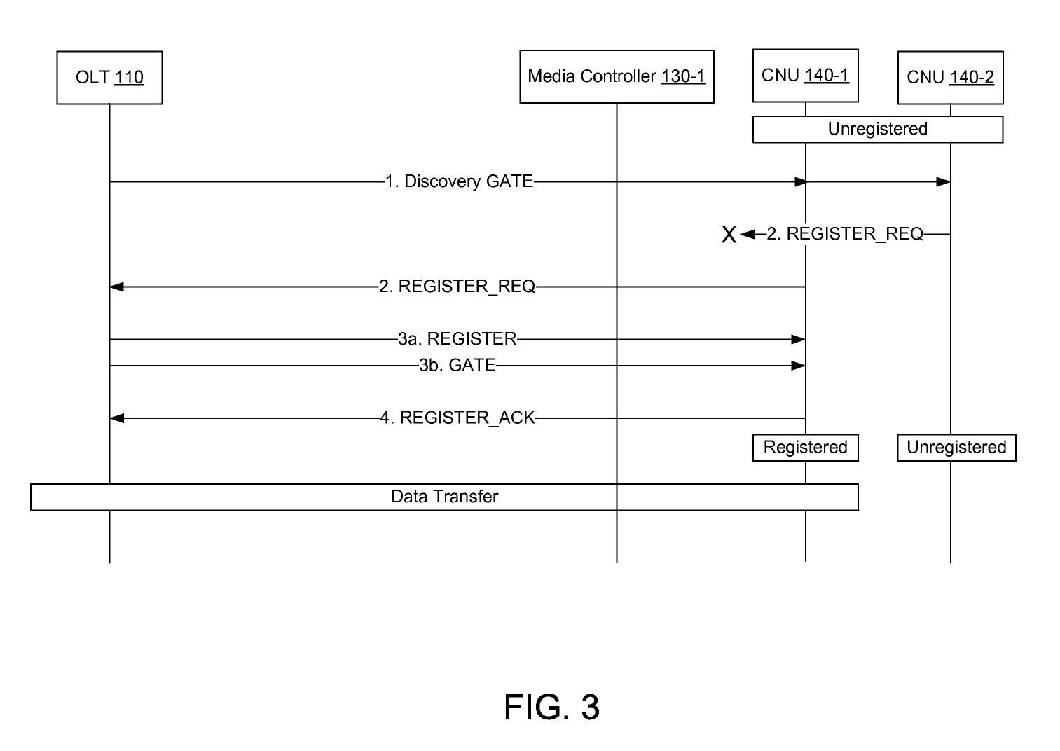

An analogous procedure to that of FIG. 2 is performed to register CNUs 140, as illustrated in FIG. 3 in accordance with some embodiments. In the procedure of FIG. 3, the messages are transmitted between the OLT 110 and CNUs 140-1 and 140-2 through the media converter 130-1. The media converter 130-1 monitors the messages, detects the LLIDs, and updates its filter template accordingly. When a CNU 140 registers with the OLT 110, the media converter 130-1 adds the LLID for the CNU 140 to the filter template. If the media converter 130-1 subsequently receives a packet specifying that LLID, it forwards the packet. (In some embodiments, an LLID also is added to the list of LLIDs in the filter template in response to upstream transmission of a data packet to the media controller 130-1 from a CNU 140 that is not listed in the filter template.) When a CNU 140 unregisters, the media converter 130-1 removes the LLID for the CNU 140 from the filter template. If the media converter 130-1 subsequently receives a packet specifying that LLID, it discards the packet and does not forward it. The media converter 130-1 thereby performs a packet sniffing and filtering process to determine whether to forward or discard packets.

The media converter 130-1 thus tracks registration and deregistration events, as indicated by corresponding messages (e.g., MPCP messages), for CNUs 140 in its domain (e.g., on its cable plant 150-1), and updates the filter template accordingly.

In some embodiments, to monitor the messages shown in FIG. 3, the media converter 130-1 reads all frames of 64-byte size and extracts MPCP frames by checking the type. To do this, the media converter 130-1 opens the frames. The messages are parsed in the media converter 130-1 by filtering on preambles for CNU data. Table 1 illustrates various fields for a frame. The media converter 130-1 analyzes respective fields to determine the message type corresponding to the frame. In the example of Table 1, the Length/Type data (88-08) indicates an MPCP message, the opcode (02) indicates a GATE message, and the number of grants/flags (09) indicates a Discovery message.

TABLE 1

Preamble - broadcast
Destination Address (DA)
Source Address (SA)
Length/Type = 88-08
Opcode = 00-02
Time Stamp
Number of grants/flags = 09
Grant start time
Grant length
Sync time
Pad = 00
Frame check sequence

For example, if a discovery GATE message is detected in step 1 of FIG. 3, the media converter 130 recognizes that a registration process has begun. If a subsequent REGISTER_REQ message is received in step 2 of FIG. 3, as identified by its frame size (e.g., 64 bytes), message type (e.g., 88-08) and opcode (e.g., 04), then the media converter 130 stores a record of this message along with the source address of the coax network unit that sent the message. If a REGISTER message is then received in step 3a of FIG. 3 for a CNU 140 with a destination address equal to the source address of the REGISTER_REQ message, the media converter 130 stores the LLID specified in the REGISTER message and associates the LLID with the source address of the REGISTER_REQ message. In some embodiments, the REGISTER message is identified by its frame size (e.g., 64 bytes), message type (e.g., 88-08) and opcode (e.g., 05). Upon receipt of a subsequent REGISTER_ACK message in step 4 of FIG. 3 (e.g., as identified by a frame size of 64 bytes, a message type of 88-08, an opcode of 06, and a source address equal to the source address of the REGISTER_REQ message), the LLID and associated source address for the newly registered CNU 140 are added to the filter template.

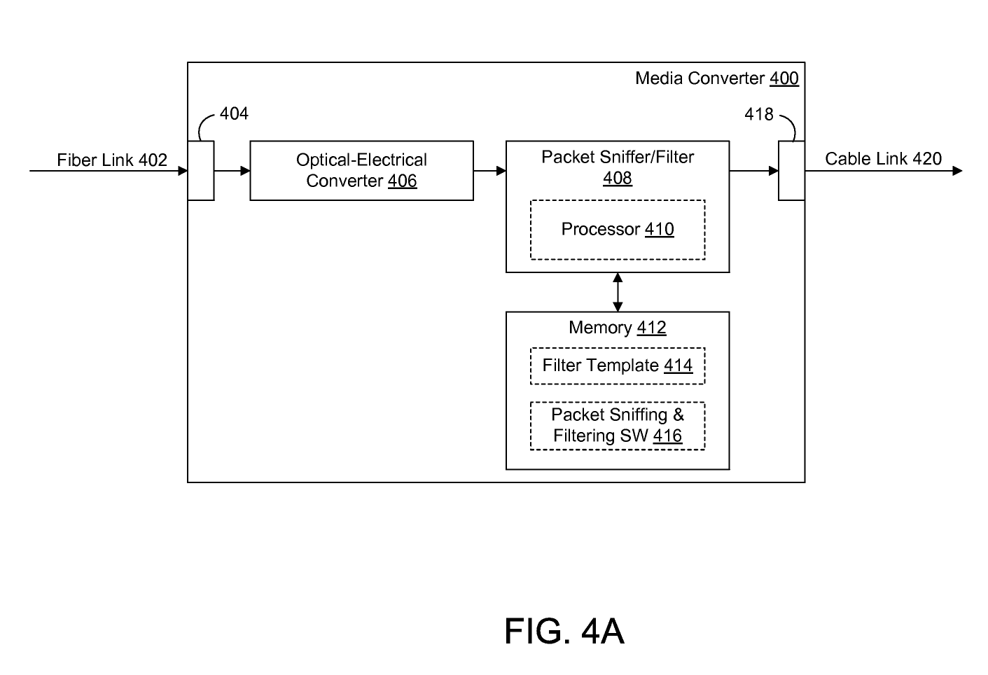

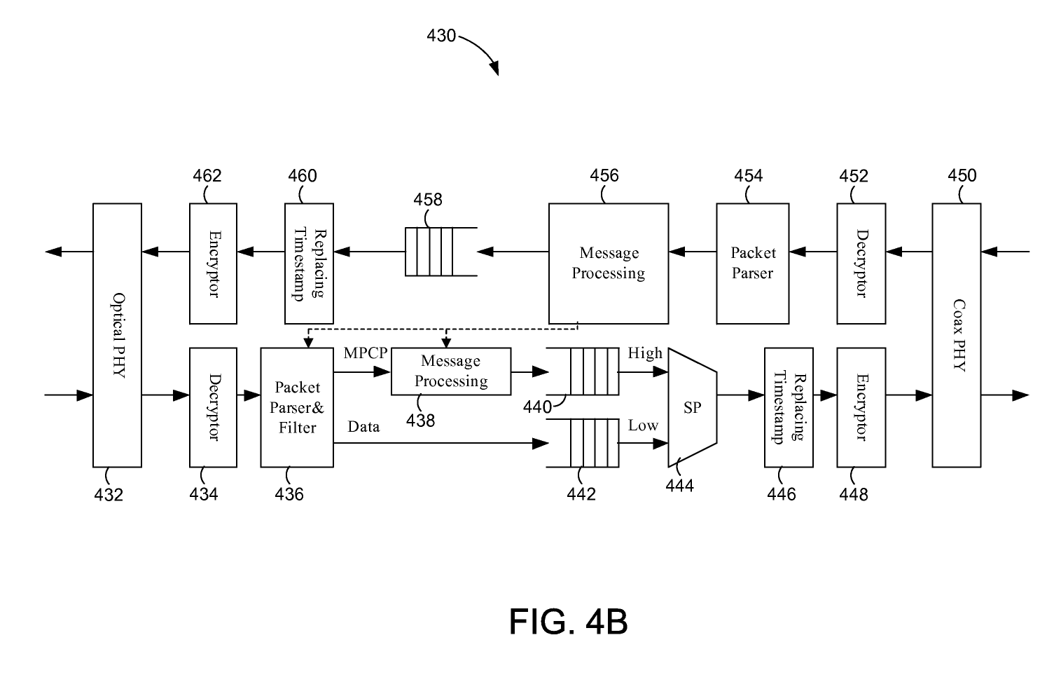

FIG. 4A is a block diagram of a media converter 400 in a network with both optical fiber links and coax links (e.g., the network 100, FIG. 1) in accordance with some embodiments. The media converter 400 is an example of a media converter 130 (FIG. 1). An optical port 404 in the converter 400 connects to a fiber link 402, thereby coupling the converter 400 to an OLT 110 (FIG. 1). The optical port 404 provides optical signals received from the fiber link 402 to an optical-to-electrical converter 406 (e.g., an optical PHY 432, FIG. 4B), which converts the optical signals to electrical signals. Coupled to the optical-to-electrical converter 406 is a packet sniffer and filter 408 that determines whether to forward or discard respective packets. For example, packets addressed to a CNU 140 on the cable plant of the media converter 400 are forwarded, while packets that are not addressed to a CNU 140 on the cable plant of the media converter 400 are discarded. Packets that the sniffer/filter 408 determines are to be forwarded are provided to one or more coax ports 418 coupled to the sniffer/filter 408. The one or more coax ports 418 transmit the packets onto respective cable links 420. Cable links 420 couple the media converter 400 to CNUs 140 on the cable plant of the media converter 400.

The sniffer/filter 408 can be implemented in hardware, software, or a combination of hardware and software. In some embodiments, the sniffer/filter 408 is implemented in a packet parser and filter 436 (FIG. 4B). In some embodiments, the sniffer/filter 408 includes a processor 410 coupled to a memory 412. The memory 412 stores a filter template 414 that includes a table or list of identifiers (e.g., LLIDs) of CNUs (e.g., registered CNUs) on the cable plant of the media converter 400. The processor 410 extracts the destination addresses of respective packets (e.g., as indicated by respective LLIDs) and compares the destination addresses to the CNU identifiers (e.g., LLIDs) in the filter template 414. If a respective destination address matches one of the CNU identifiers in the filter template 414, the corresponding packet is forwarded. If there is no match, the corresponding packet is discarded. The processor 410 also updates the filter template 414. For example, the processor 410 monitors registration messages (e.g., in accordance with FIG. 3) and adds the LLIDs for newly registered CNUs 140 to the filter template 414. The processor 410 also deletes LLIDs for deregistered CNUs 140 from the filter template 414.

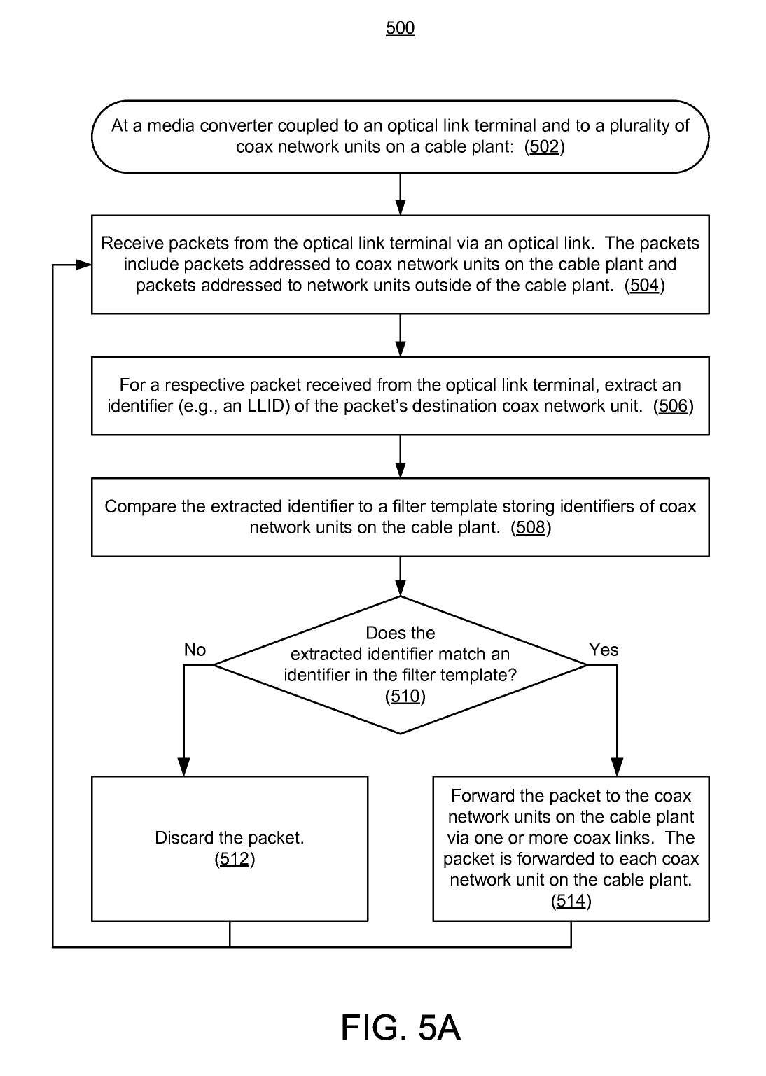

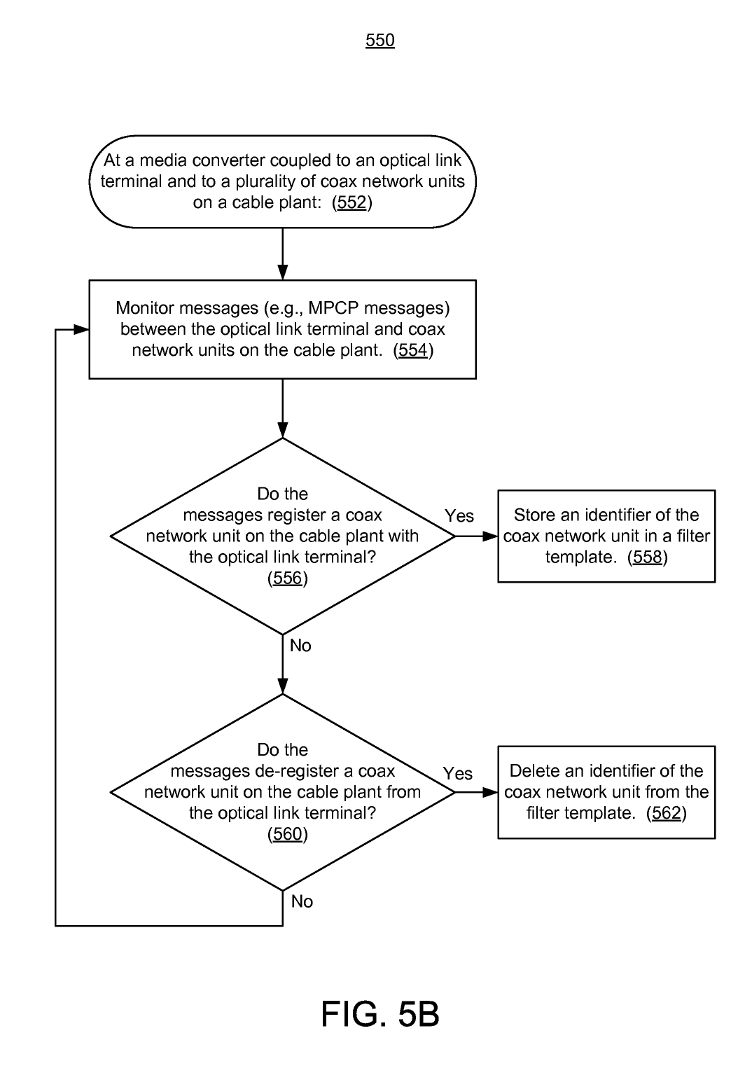

In some embodiments, the memory 412 includes a non-transitory computer-readable medium (e.g., one or more nonvolatile memory elements, such as EPROM, EEPROM, Flash memory, a hard disk drive, and so on) that stores a packet sniffing and filtering software module 416. The packet sniffing and filtering software module 416 includes instructions that, when executed by the processor 410, cause the media converter 400 to perform the packet sniffing and filtering described herein. The module 416 also includes instructions that, when executed by the processor 410, cause the filtering template 414 to be updated (e.g., as described with regard to FIG. 3 and Table 1). In some embodiments, the module 416 stores instructions that, when executed by one or more processors (e.g., processor 410, FIG. 4A, and/or message processors 438 and 456, FIG. 4B), cause the media converter 400 to perform the methods 500 and/or 550 (FIGS. 5A and 5B).

While the memory 412 is shown as being separate from the processor 410, all or a portion of the memory 412 may be embedded in the processor 410. For example, all or a portion of the filter template 414 may be stored in a cache in the processor 410.

FIG. 4B is a schematic block diagram of an example of a media converter 430 shown in more detail than for the media converter 400 (FIG. 4A) in accordance with some embodiments. The media converter 430 is an example of a media converter 130 (e.g., media converter 130-1 or 130-2, FIG. 1). In the downstream direction, packets are received at an optical PHY 432 and provided to a decryptor 434 followed by a packet parser and filter 436. The optical PHY 432 is an example of the optical-electrical converter 406 (FIG. 4A) and the packet parser and filter 436 includes the packet sniffer/filter 408 (FIG. 4A) and may include (or be coupled to) all or a portion of the memory 412 (e.g., the filter template 414, FIG. 4A).

The filter portion (e.g., packet sniffer/filter 408, FIG. 4A) of the packet parser and filter 436 discards packets that are not addressed to CNUs 140 that are coupled to the media converter 430. The output of the packet parser and filter 436 is split into two streams: one for MPCP packets (e.g., messages such as those shown in FIG. 3) and one for data packets. The MPCP packets are processed by a message processing engine 438, which monitors downstream messages and in some embodiments maps allocated time slots to coax frequency resources, and are passed into a control queue 440. The message processing engine 438 is also referred to as a message processor. The data packets are passed into a data queue 442. A strict priority (SP) scheduler 444 schedules the packets in the control and data queues 440 and 442, with MPCP packets in the control queue 440 being given priority over data packets in the data queue 442. A time-stamping element 446 updates timestamps carried in MPCP packets (e.g., replaces the original timestamps with local timestamps) and passes packets into an encryptor 448. The output of the encryptor 418 is fed into a coax PHY 450, which transmits the packets downstream. The coax PHY 450 is coupled to or implemented in a coax ports 418 (FIG. 4A).

In the upstream direction, packets are received at the coax PHY 450 and provided to a decryptor 452, followed by a packet parser 454, a message processor 456, and an upstream queue 458. The message processor 456 monitors upstream messages (e.g., the upstream messages of FIG. 3) and in some embodiments communicates results of this monitoring to the message processor 438 and/or packet parser and filter 436. A time-stamping element 460 updates the timestamps carried in MPCP packets (e.g., replaces the original timestamps with local timestamps) and passes packets to an encryptor 462. The output of the encryptor 462 is fed into the optical PHY 432, which transmits the packets upstream to the OLT 110 (FIG. 1).

FIG. 5A is a flowchart illustrating a method 500 of filtering packets in a media converter in accordance with some embodiments. The method 500 is performed (502) by a media converter (e.g., media converter 130-1 or 130-2, FIG. 1) that is coupled to an optical link terminal (e.g., OLT 110, FIG. 1) and to a plurality of coax network units (e.g., CNUs 140-1 and 140-2 or CNUs 140-3 through 140-5, FIG. 1) on a cable plant (e.g., cable plant 150-1 or 150-2, FIG. 1).

Packets are received (504) from the optical link terminal via an optical link. The packets include packets addressed to coax network units on the cable plant and packets addressed to network units outside of the cable plant. The packets are received at a first data rate.

For a respective packet received from the optical link terminal, an identifier (e.g., an LLID) of the packet's destination coax network unit is extracted (506) and compared (508) to a filter template (e.g., filter template 414, FIG. 4A) storing identifiers of coax network units on the cable plant. It is determined (510) if the extracted identifier matches an identifier in the filter template.

If the extracted identifier matches an identifier in the filter template (510—Yes), the packet is forwarded (514) to the coax network units on the cable plant via one or more coax links. The packet is forwarded to each coax network unit on the cable plant. In some embodiments, the packets are forwarded at a second data rate that is distinct from (e.g., less than) the first data rate.

If the extracted identifier does not match an identifier in the filter template (510—No), the packet is discarded (512) and thus is not forwarded to the coax network units on the cable plant.

In some embodiments, the operations 506-514 are performed in the packet sniffer/filter 408 (FIG. 4A) of the packet parser and filter 436 (FIG. 4B).

FIG. 5B is a flowchart illustrating a method 550 of creating and updating a filtering template in accordance with some embodiments. The method 550 is performed (552) by a media converter (e.g., media converter 130-1 or 130-2, FIG. 1) that is coupled to an optical link terminal (e.g., OLT 110, FIG. 1) and to a plurality of coax network units (e.g., CNUs 140-1 and 140-2 or CNUs 140-3 through 140-5, FIG. 1) on a cable plant (e.g., cable plant 150-1 or 150-2, FIG. 1) and may be performed in conjunction with the method 500 (FIG. 5A).

The media converter monitors (554) messages (e.g., MPCP messages) between the optical link terminal and coax network units on the cable plant. This monitoring is performed, for example, by the message processing elements 438 and 456 and/or the packet parser and filter 436 (FIG. 4B). It is determined (556) if the messages register a coax network unit on the cable plant with the optical link terminal. For example, it is determined whether the messages correspond to the messages for the registration process shown in FIG. 3. If so (556—Yes), an identifier (e.g., an LLID specified in the REGISTER message of step 3a, FIG. 3) of the coax network unit is stored (558) in a filter template (e.g., filter template 414, FIG. 4A). Once the identifier has been added to the filter template, packets addressed to the coax network unit will be forwarded (e.g., in accordance with operation 514, FIG. 5A) instead of being discarded.

It is determined (560) if the messages de-register a coax network unit on the cable plant from the optical link terminal. If so (560—Yes), an identifier of the coax network unit is deleted (562) from the filter template (e.g., filter template 414, FIG. 4A). Once the identifier has been deleted from the filter template, packets addressed to the coax network unit will be discarded (e.g., in accordance with operation 512, FIG. 5A) instead of being forwarded.

In some embodiments, an identifier of an unregistered coax network unit also may be added to the filter template if the media converter receives a data packet from the coax network unit.

While the methods 500 and 550 include a number of operations that appear to occur in a specific order, it should be apparent that the methods 500 and/or 550 can include more or fewer operations, which can be executed serially or in parallel. An order of two or more operations may be changed and two or more operations may be combined into a single operation. In some embodiments, the operations of both methods 500 and 550 are performed on an ongoing basis.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of operating a media converter coupled to an optical link terminal and to a plurality of coax network units on a cable plant, the method comprising:
receiving packets from the optical link terminal via an optical link, the packets comprising first packets addressed to coax network units on the cable plant and second packets addressed to network units outside of the cable plant;
forwarding the first packets to the coax network units on the cable plant via one or more coax links, wherein the first packets are forwarded to each coax network unit on the cable plant; and
discarding the second packets.

2. The method of claim 1, wherein:
the packets from the optical link terminal are received at a first data rate; and
the first packets are forwarded to the coax network units at a second data rate that is less than the first data rate.

3. The method of claim 2, wherein the first data rate is 10 Gbps and the second data rate is 1 Gbps.

4. The method of claim 1, further comprising:
for a respective packet received from the optical link terminal, extracting an identifier of a destination coax network unit; and
comparing the extracted identifier to a filter template storing identifiers of coax network units on the cable plant.

5. The method of claim 4, further comprising:
determining that the extracted identifier matches an identifier in the filter template; and
in response to the determining, forwarding the respective packet to the plurality of coax network units on the cable plant.

6. The method of claim 4, further comprising:
determining that the extracted identifier does not match any identifiers in the filter template; and
in response to the determining, discarding the respective packet.

7. The method of claim 4, wherein the extracting comprises extracting a logical link identifier (LLID) from a preamble of a frame corresponding to the respective packet.

8. The method of claim 4, further comprising:
monitoring messages between the optical link terminal and a first coax network unit on the cable plant, wherein the messages register the first coax network unit with the optical link terminal; and
in response to the messages, storing an identifier of the first coax network unit in the filter template.

9. The method of claim 8, wherein the messages comprise multi-point control protocol (MPCP) messages.

10. The method of claim 8, wherein monitoring the messages comprises:
detecting a registration message from the optical link terminal to the first coax network unit assigning an identifier to the first coax network unit; and
detecting a registration acknowledgment message from the first coax network unit to the optical link terminal.

11. The method of claim 10, wherein monitoring the messages further comprises:
before detecting the registration message, detecting a discovery GATE message from the optical link terminal and a registration request message from the first coax network unit; and
after detecting the register message and before detecting the registration acknowledgment message, detecting a GATE message from the optical link terminal to the first coax network unit.

12. The method of claim 8, further comprising:
detecting de-registration of a second coax network unit on the cable plant; and
in response to detecting the de-registration, deleting an identifier of the second coax network unit from the filter template.

13. The method of claim 4, further comprising:
receiving a data packet from a coax network unit having an identifier that is not in the filter template; and
adding to the filter template the identifier of the coax network unit from which the data packet is received.

14. A media converter, comprising:
an optical port to couple to an optical link;
a coax port to couple to a cable plant; and
a packet sniffing and filtering module, coupled between the optical port and the coax port, to filter packets received on the optical port, wherein the packet sniffing and filtering module is to forward packets addressed to coax network units on the cable plant to the coax port for transmission and is to discard packets addressed to network units outside of the cable plant.

15. The media converter of claim 14, wherein the optical port has a first data rate and the coax port has a second data rate that is less than the first data rate.

16. The media converter of claim 14, further comprising a memory, coupled to the packet sniffing and filtering module, to store a filter template listing identifiers of coax network units on the cable plant, wherein the packet sniffing and filtering module is to extract identifiers of destination coax network units from the packets received on the optical port and compare the extracted identifiers to the filter template.

17. The media converter of claim 16, wherein the packet sniffing and filtering module is to extract logical link identifiers (LLIDs) from preambles of frames corresponding to the packets received on the optical port.

18. The media converter of claim 16, wherein the media converter is to monitor messages between an optical link terminal and a first coax network unit on the cable plant, wherein the messages register the first coax network unit with the optical link terminal, and to store an identifier of the first coax network unit in the filter template in response to the messages.

19. A non-transitory computer-readable storage medium storing instructions that, when executed by one or more processors in a media converter, cause the media converter to:
extract identifiers of destination coax network units from packets received on an optical port;
compare the extracted identifiers to a filter template storing identifiers of coax network units;
forward packets for which the extracted identifiers match an identifier in the filter template; and
discard packets for which the extracted identifiers do not match any identifiers in the filter template.

20. The computer-readable storage medium of claim 19, further storing instructions that, when executed by the one or more processors, cause the media converter to:
monitor messages between an optical link terminal and a first coax network unit on the cable plant, wherein the messages register the first coax network unit with the optical link terminal; and
store an identifier of the first coax network unit in the filter template in response to the messages.
